(19) United States
(12) Patent Application Publication
(10) Pub. No.: US 2015/0212442 A1
(43) Pub. Date: Jul. 30, 2015

(54) TONER, DEVELOPER, DEVELOPER CONTAINER, AND IMAGE FORMING APPARATUS

(71) Applicants: Masayuki ISHII, Shizuoka (JP); Toyoshi SAWADA, Kanagawa (JP); Keiji MAKABE, Shizuoka (JP)

(72) Inventors: Masayuki ISHII, Shizuoka (JP); Toyoshi SAWADA, Kanagawa (JP); Keiji MAKABE, Shizuoka (JP)

(21) Appl. No.: 14/607,287

(22) Filed: Jan. 28, 2015

(30) Foreign Application Priority Data
Jan. 30, 2014 (JP) 2014-015877

(51) Int. Cl. G03G 9/00

(52) U.S. Cl. CPC G03G 9/08733; G03G 9/0819

(57) ABSTRACT

A toner is provided. The toner includes mother toner particles. Each mother toner particle includes a binder resin and inorganic-layer-containing resin particles. Each inorganic-layer-containing resin particle includes a resin particle and an inorganic layer on the surface of the resin particle.

### CROSS-REFERENCE TO RELATED APPLICATIONS

This patent application is based on and claims priority pursuant to 35 U.S.C. §119(a) to Japanese Patent Application No. 2014-015877, filed on Jan. 30, 2014, in the Japan Patent Office, the entire disclosure of which is hereby incorporated by reference herein.

### BACKGROUND

1. Technical Field

The present disclosure relates to a toner, a developer, a developer container, and an image forming apparatus.

2. Description of the Related Art

In an electrophotographic apparatus or electrostatic recording apparatus, an electric or magnetic latent image is generally formed into a visible image with toner. Specifically, in electrophotography, an electrostatic latent image is formed on a photoconductor and then developed into a toner image with a toner. The toner image is transferred onto a transfer material such as paper and then fixed thereon by application of heat or other means. Toner for developing electrostatic latent image is generally composed of colored particles in which a colorant, a charge controlling agent, and other additives are contained in a binder resin. Method for producing toner is roughly of two types: pulverization method and polymerization method.

In a typical pulverization method, a colorant, a charge controlling agent, an offset inhibitor, etc. are uniformly dispersed in a thermoplastic resin by means of melt-mixing, and the resulting composition is pulverized and classified to obtain a toner.

The pulverization method is capable of producing toner with a certain level of quality. However, there is a limit in selecting raw materials for toner. For example, the composition obtained by melt-mixing should be pulverized and classified by apparatuses operable in an economical manner. To meet this requirement, the composition has to be brittle as much as possible. It is likely that such a brittle composition is pulverized into particles with a wide particle diameter distribution. On the other hand, to obtain high-resolution and high-gradation copied image with such particles, ultrafine particles having a particle diameter of 5 μm or less, more specifically 3 μm or less, and coarse particles having a particle diameter of 20 μm or more should be removed with adversely affecting the yield. It is generally difficult for the pulverization method to uniformly disperse a colorant, a release agent, etc. in a thermoplastic resin. In the toner obtained by the pulverization method, the colorant is exposed at the surface of the toner. This results in numerous problems such as nonuniform and wide-distribution toner charge and deterioration of developing property. The pulverization method cannot respond to demands for improving various toner properties.

To overcome the problems of the pulverization method, polymerization method has been proposed and used. One example of the polymerization method includes suspension polymerization method.

The polymerization method has neither pulverizing nor kneading process. Therefore, the polymerization method largely contributes to energy saving, reduction of production time, improvement in yield, and reduction of cost. It is easy for the polymerization method to produce toner particles with a smaller particle diameter and a narrower particle diameter distribution, which contributes to high image quality. The polymerization method is said to be a promising technology.

Charge stability is one of very important toner properties, for both pulverization and polymerization toners, which affects the resulting image quality.

On the other hand, for the purpose of saving energy, toner having low-temperature fixability is being used lately. Various technologies have been proposed to obtain such a toner having low-temperature fixability. Generally, the most effective way for improving low-temperature fixability of toner is to reduce the glass transition temperature of the resin contained in toner.

However, there is a problem that the toner having low-temperature fixability is insufficient in charge stability.

Accordingly, toner having excellent charge stability has been demanded.

### SUMMARY

In accordance with some embodiments of the present invention, a toner is provided. The toner includes mother toner particles. Each mother toner particle includes a binder resin and inorganic-layer-containing resin particles. Each inorganic-layer-containing resin particle includes a resin particle and an inorganic layer on the surface of the resin particle.

In accordance with some embodiments of the present invention, a developer is provided. The developer includes the above toner and a carrier.

In accordance with some embodiments of the present invention, a developer container is provided. The developer container includes a container and the above toner contained in the container.

In accordance with some embodiments of the present invention, an image forming apparatus is provided. The image forming apparatus includes an electrostatic latent image bearer, an electrostatic latent image forming device, and a developing device. The electrostatic latent image forming device forms an electrostatic latent image on the electrostatic latent image bearer. The developing device develops the electrostatic latent image formed on the electrostatic latent image bearer into a visible image with the above toner.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to an embodiment of the present invention;

FIG. 2 is a schematic view of an image forming apparatus according to an embodiment of the present invention;

FIG. 3 is a schematic view of an image forming apparatus according to an embodiment of the present invention;

FIG. 4 is a partial magnified view of FIG. 3; and

FIG. 5 is a schematic view of a process cartridge according to an embodiment of the present invention.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

One object of the present invention is to provide a toner having excellent charge stability.

In accordance with some embodiments of the present invention, toner having excellent charge stability is provided.

### Toner

The toner according to an embodiment of the present invention includes at least mother toner particles and optionally other components.

### Mother Toner Particles

Each mother toner particle includes at least a binder resin and inorganic-layer-containing resin particles and optionally other components.

### Binder Resin

Specific examples of the binder resin include, but are not limited to, styrene-based copolymer, polymethyl methacrylate resin, polybutyl methacrylate resin, polyvinyl chloride resin, polyvinyl acetate resin, polyethylene resin, polyester resin, polyurethane resin, epoxy resin, polyvinyl butyral resin, polyacrylic acid resin, rosin resin, modified rosin resin, terpene resin, phenol resin, aliphatic or aromatic hydrocarbon resin, and aromatic petroleum resin. Specific examples of the styrene-based copolymer include, but are not limited to, homopolymers of styrene or substitutes thereof (e.g., polystyrene, poly(p-chlorostyrene), polyvinyl toluene), styrene-p-chlorostyrene copolymer, styrene-propylene copolymer, styrene-vinyl toluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, and styrene-maleate copolymer.

Among these binder resins, polyester resin is preferable from the viewpoint of durability and fixability.

These binder resins can be used alone or in combination.

### Polyester Resin

The polyester resin is preferably prepared from a polyol and a polycarboxylic acid as main components.

Specific examples of the polyol include, but are not limited to, a diol, an alcohol having 3 or more valences, and a mixture of a diol with an alcohol having 3 or more valences. In particular, a diol and a mixture of a diol with a small amount of an alcohol having 3 or more valences are preferable. These materials can be used alone or in combination.

Specific examples of the diol include, but are not limited to, alkylene glycols (e.g., ethylene glycol, 1,2-propylene glycol, 1,3-propylene glycol, 1,4-butanediol, 1,6-hexanediol); diols having an oxyalkylene group (e.g., diethylene glycol, triethylene glycol, dipropylene glycol, polyethylene glycol, polypropylene glycol, polytetramethylene glycol); alicyclic diols (e.g., 1,4-cyclohexanedimethanol, hydrogenated bisphenol A); alicyclic diols to which an alkylene oxide, such as ethylene oxide, propylene oxide, or butylene oxide, is adducted; bisphenols (e.g., bisphenol A, bisphenol F, bisphenol S); and bisphenols to which an alkylene oxide, such as ethylene oxide, propylene oxide, or butylene oxide, is adducted. The alkylene glycols preferably have a carbon number of from 2 to 12. Among these diols, alkylene glycols having a carbon number of from 2 to 12, or alkylene oxide adducts of bisphenols are preferable; and alkylene oxide adducts of bisphenols, or a mixture of an alkylene oxide adduct of a bisphenol with an alkylene glycol having a carbon number of from 2 to 12 are more preferable.

These materials can be used alone or in combination.

Specific examples of the alcohol having 3 or more valences include, but are not limited to, an aliphatic alcohol having 3 or more valences, a polyphenol having 3 or more valences, and an alkylene oxide adduct of a polyphenol having 3 or more valences.

Specific examples of the aliphatic alcohol having 3 or more valences include, but are not limited to, glycerin, trimethylolethane, trimethylolpropane, pentaerythritol, and sorbitol.

Specific examples of the polyphenol having 3 or more valences include, but are not limited to, trisphenol PA, phenol novolac, and cresol novolac.

Specific examples of the alkylene oxide adduct of a polyphenol having 3 or more valences include, but are not limited to, polyphenols having 3 or more valences to which an alkylene oxide, such as ethylene oxide, propylene oxide, or butylene oxide, is adducted.

These materials can be used alone or in combination.

When the diol and the alcohol having 3 or more valences are used in combination, the ratio of the alcohol having 3 or more valences to the diol is preferably from 0.01% to 10% by weight and more preferably from 0.01% to 1% by weight.

Specific examples of the polycarboxylic acid include, but are not limited to, a dicarboxylic acid, a carboxylic acid having 3 or more valences, and a mixture of a dicarboxylic acid with a carboxylic acid having 3 or more valences. In particular, a dicarboxylic acid and a mixture of a dicarboxylic acid with a small amount of a polycarboxylic acid having 3 or more valences are preferable. These materials can be used alone or in combination.

Specific examples of the dicarboxylic acid include, but are not limited to, a divalent alkanoic acid, a divalent alkene acid, and an aromatic dicarboxylic acid.

Specific examples of the divalent alkanoic acid include, but are not limited to, succinic acid, adipic acid, and sebacic acid.

The divalent alkene acid preferably has a carbon number of from 4 to 20. Specific examples of the divalent alkene acid having a carbon number of from 4 to 20 include, but are not limited to, maleic acid and fumaric acid.

The aromatic dicarboxylic acid preferably has a carbon number of from 8 to 20. Specific examples of the aromatic dicarboxylic acid having a carbon number of from 8 to 20 include, but are not limited to, phthalic acid, isophthalic acid, terephthalic acid, and naphthalenedicarboxylic acid.

Among these polycarboxylic acids, divalent alkanoic acids and aromatic dicarboxylic acids having a carbon number of from 8 to 20 are preferable.

These materials can be used alone or in combination.

Specific examples of the carboxylic acid having 3 or more valences include, but are not limited to, an aromatic carboxylic acid having 3 or more valences.

The aromatic carboxylic acid having 3 or more valences preferably has a carbon number of from 9 to 20. Specific examples of the aromatic carboxylic acid having 3 or more valences and a carbon number of from 9 to 20 include, but are not limited to, trimellitic acid and pyromellitic acid.

Specific examples of the polycarboxylic acid further include acid anhydrides and lower alkyl esters of the dicarboxylic acid, the carboxylic acid having 3 or more valences, or the mixture of the dicarboxylic acid with the carboxylic acid having 3 or more valences. Specific examples of the lower alkyl esters include, but are not limited to, methyl ester, ethyl ester, and isopropyl ester.

When the dicarboxylic acid and the carboxylic acid having 3 or more valences are used in combination, the ratio of the carboxylic acid having 3 or more valences to the dicarboxylic acid is preferably from 0.01% to 10% by weight and more preferably from 0.01% to 1% by weight.

The mixing ratio of the polyol with the polycarboxylic acid at the time of polycondensation is determined such that the molar equivalent ratio of the hydroxyl groups in the polyols to the carboxyl groups in the polycarboxylic acid ranges from 1 to 2, preferably from 1 to 1.5, and more preferably from 1.02 to 1.3. When the molar equivalent ratio falls below 1, offset resistance may deteriorate. When the molar equivalent ratio exceeds 2, low-temperature fixability may deteriorate.

The polyester resin preferably has a weight average molecular weight of from 1,000 to 50,000, more preferably from 2,000 to 30,000, and most preferably from 5,000 to 20,000.

The polyester resin preferably has a glass transition temperature of from 40° C. to 80° C., more preferably from 50° C. to 70° C.

The glass transition temperature can be measured by differential scanning calorimetry (DSC).

Usable binder resin is not limited to the above-described polycondensation product of the polyol with the polycarboxylic acid and further includes a cross-linking and/or elongation reaction product of a compound having an active hydrogen group with a polymer (hereinafter maybe referred to as “prepolymer”) having a site reactive with the compound having an active hydrogen group.

As the polymer having a site reactive with the compound having an active hydrogen group, a modified polyester resin reactive with the compound having an active hydrogen group is preferably used.

As the modified polyester resin reactive with the compound having an active hydrogen group, a polyester resin having an isocyanate group is preferably used. When the polyester resin having an isocyanate group is reacted with the compound having an active hydrogen group, an alcohol can be optionally added to form urethane bonds. The molar ratio of the urethane bonds to urea bonds is preferably from 0 to 9, more preferably from 1/4 to 4, and most preferably from 2/3 to 7/3. When the molar ratio exceeds 9, hot offset resistance may deteriorate.

The compound having an active hydrogen group acts as an elongating agent or a cross-linking agent for elongating or cross-linking the polymer having a site reactive with the compound having an active hydrogen group in an aqueous medium. Specific examples of the active hydrogen group in the compound having an active hydrogen group include, but are not limited to, a hydroxyl group (e.g., an alcoholic hydroxyl group, a phenolic hydroxyl group), an amino group, a carboxyl group, and a mercapto group.

When a polyester resin having an isocyanate group is used as the polymer having a site reactive with the compound having an active hydrogen group, an amine is preferably used as the compound having an active hydrogen group because the amine is capable of polymerizing the polyester resin having an isocyanate group by an elongation or cross-linking reaction.

Specific examples of the amine include, but are not limited to, a diamine, an amine having 3 or more valences, an amino alcohol, an amino mercaptan, an amino acid, and a blocked amine in which the amino group in any of these is blocked. In particular, a diamine and a mixture of a diamine with a small amount of amine having 3 or more valences are preferable. These materials can be used alone or in combination.

Specific examples of the diamine include, but are not limited to, an aromatic diamine, an alicyclic diamine, and an aliphatic diamine.

Specific examples of the aromatic diamine include, but are not limited to, phenylenediamine, diethyltoluenediamine, and 4,4′-diaminodiphenylmethane.

Specific examples of the alicyclic diamine include, but are not limited to, 4,4′-diamino-3,3′-dimethyldicyclohexylmethane, diaminocyclohexane, and isophoronediamine.

Specific examples of the aliphatic diamine include, but are not limited to, ethylenediamine, tetramethylenediamine, and hexamethylenediamine.

These materials can be used alone or in combination.

Specific examples of the amine having 3 or more valences include, but are not limited to, diethylenetriamine and triethylenetetramine. These materials can be used alone or in combination.

Specific examples of the amino alcohol include, but are not limited to, ethanolamine and hydroxyethylaniline. These materials can be used alone or in combination.

Specific examples of the amino mercaptan include, but are not limited to, aminoethyl mercaptan and aminopropyl mercaptan. These materials can be used alone or in combination.

Specific examples of the amino acid include, but are not limited to, aminopropionic acid and aminocaproic acid. These materials can be used alone or in combination.

Specific examples of the blocked amine include, but are not limited to, ketimine compounds obtained by blocking the amino group in any of these amines with ketones (e.g., acetone, methyl ethyl ketone, methyl isobutyl ketone), and oxazoline compounds. These materials can be used alone or in combination.

To terminate an elongation and/or cross-linking reaction of the compound having an active hydrogen group with the polymer having a site reactive with the compound having an active hydrogen group, a reaction terminator can be used. By using the reaction terminator, the binder resin can be controlled to have a desired molecular weight. Specific examples of the reaction terminator include, but are not limited to, monoamines (e.g., diethylamine, dibutylamine, butylamine, laurylamine) and ketimine compounds in which the amino group in any of these monoamines is blocked.

Specific examples of the prepolymer include, but are not limited to, a polyol resin, a polyacrylic resin, a polyester resin, an epoxy resin, and a derivative thereof. Among these resins, a polyester resin is preferable owing to its high flowability at the time of melting and transparency. These materials can be used alone or in combination.

Specific examples of the site reactive with the compound having an active hydrogen group in the prepolymer include, but are not limited to, an isocyanate group, an epoxy group, a carboxyl group, and a functional group represented by the chemical formula —COCl. Among these functional groups, an isocyanate group is preferable. These functional groups can be included in the prepolymer alone or in combination.

As the prepolymer, a polyester resin capable of forming urea bonds, such as that having an isocyanate group, is preferably used because the molecular weight of high-molecular-weight components thereof is easily adjustable and such a resin is capable of providing excellent separability and fixability even in a fixing system with no oil applicator for applying oil to a heat-fixing member, i.e., excellent oilless low-temperature fixability.

Specific examples of the polyester resin having an isocyanate group include, but are not limited to, a reaction product of a polyisocyanate with a polyester resin having a hydroxyl group obtained by a polycondensation of the polyol with the polycarboxylic acid.

Specific examples of the polyisocyanate include, but are not limited to, an aliphatic diisocyanate, an alicyclic diisocyanate, an aromatic diisocyanate, an aromatic aliphatic diisocyanate, an isocyanurate, and any of these polyisocyanates which is blocked with a phenol derivative, an oxime, or a caprolactam.

Specific examples of the aliphatic diisocyanate include, but are not limited to, tetramethylene diisocyanate, hexamethylene diisocyanate, 2,6-diisocyanatocaproic acid methyl ester, octamethylene diisocyanate, decamethylene diisocyanate, dodecamethylene diisocyanate, tetramethylene diisocyanate, trimethylhexane diisocyanate, and tetramethylhexane diisocyanate.

Specific examples of the alicyclic diisocyanate include, but are not limited to, isophorone diisocyanate and cyclohexylmethane diisocyanate.

Specific examples of the aromatic diisocyanate include, but are not limited to, tolylene diisocyanate, diisocyanatodiphenylmethane, 1,5-naphthylene diisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenyl ether.

Specific examples of the aromatic aliphatic diisocyanate include, but are not limited to, α,α,α′,α′-tetramethylxylylene diisocyanate.

Specific examples of the isocyanurate include, but are not limited to, tris(isocyanatoalkyl) isocyanurate and tris(isocyanatocycloalkyl) isocyanurate.

These materials can be used alone or in combination.

When the polyisocyanate is reacted with the polyester resin having a hydroxyl group, the equivalent ratio of the isocyanate groups in the polyisocyanate to the hydroxyl groups in the polyester resin is from 1 to 5, preferably from 1.2 to 4, and more preferably from 1.5 to 3. When the equivalent ratio falls below 1, offset resistance may deteriorate. When the molar equivalent ratio exceeds 5, low-temperature fixability may deteriorate.

The content of the polyisocyanate-derived constitutional units in the polyester resin having an isocyanate group is preferably from 0.5% to 40% by weight, more preferably from 1% to 30% by weight, and most preferably from 2% to 20% by weight. When the content of the units is less than 0.5% by weight, offset resistance may deteriorate. When the content of the units exceeds 40% by weight, low-temperature fixability may deteriorate.

The average number of isocyanate groups included in one molecule of the polyester resin having an isocyanate group is preferably 1 or more, more preferably from 1.5 to 3, and most preferably from 1.8 to 2.5. When the average number of isocyanate groups is less than 1, the molecular weight of the modified polyester resin may lower and hot offset resistance may deteriorate.

### Inorganic-Layer-Containing Resin Particles

The inorganic-layer-containing resin particle is not limited to any particular material so long as it includes a resin particle and an inorganic layer formed on the surface of the resin particle.

Specific usable materials for the resin particle include, but are not limited to, polymethyl methacrylate resin (PMMA), polyester resin, polyurethane resin, and polystyrene resin. Among these materials, polymethyl methacrylate resin is preferable owing to its physical strength, heat resistance, and a narrow particle size distribution.

Commercially-available materials can also be used for the resin particle. Specific usable commercially-available materials for the resin particle include, but are not limited to, MP-300 (PMMA fine particles available from Soken Chemical & Engineering Co., Ltd.) and MX-80H3wT (PMMA fine particles available from Soken Chemical & Engineering Co., Ltd.).

The inorganic layer preferably includes at least one of Si, Al, Mg, or Ca from the viewpoint of chargeability and charge transport inhibitory capacity. More preferably, the inorganic layer includes an inorganic oxide containing at least one of Si, Al, Mg, or Ca. Most preferably, the inorganic layer includes silica.

Specific examples of the inorganic oxides include, but are not limited to, silica, alumina, magnesium oxide, and calcium oxide.

The inorganic-layer-containing resin particle preferably has an average particle diameter of from 5 to 50 nm, more preferably from 10 to 40 nm, and more preferably from 15 to 35 nm. When the average particle diameter is less than 5 nm, the desired charge effect may not be obtained. When the average particle diameter exceeds 50 nm, the inorganic layer may become inhomogeneous. When the average particle diameter is within the above-described preferable range, it is advantageous in terms of homogeneity of the inorganic layer. The average particle diameter can be measured by, for example, Particle Size Distribution Analyzer LA series from HORIBA, Ltd.

A specific method of producing the inorganic-layer-containing resin particle includes, but are not limited to, a spray drying method and a sol-gel method, both of which has a process of forming the inorganic layer on the surface of the resin particle.

The spray drying method is not limited to any particular method and may include the following process.

First, the resin particles are suspended in a sol of an inorganic material that constitutes the inorganic layer, such as an inorganic oxide, and stirred by means of ultrasonic wave to prepare a suspension liquid. The suspension liquid is then sprayed into a high-temperature airflow having a temperature of about from 70° C. to 150° C. by a spray dryer device to become a fine particle liquid, followed by drying.

The sol-gel method is not limited to any particular method and may include the following process.

First, an aqueous medium composed primarily of water and the resin particles are mixed and stirred to prepare a suspension liquid. A predetermined amount of an inorganic alkoxide is then added to the suspension liquid to cause hydrolysis and condensation reactions of the inorganic alkoxide at a temperature of from 20° C. to 60° C.

The inorganic alkoxide is not limited to any particular material so long as it forms an inorganic oxide by hydrolysis and condensation reactions. Specific examples of the inorganic alkoxide include, but are not limited to, a titanium alkoxide, a silane alkoxide, and an aluminum alkoxide.

Specific examples of the titanium alkoxide include, but are not limited to, titanium tetraisopropoxide.

Specific examples of the silane alkoxide include, but are not limited to, tetraalkoxysilane.

Specific examples of the aluminum alkoxide include, but are not limited to, aluminum isopropoxide.

Specific examples of the tetraalkoxysilane include, but are not limited to, tetramethoxysilane and tetraethoxysilane.

The content of the inorganic-layer-containing resin particles in the mother toner particle is preferably from 0.1% to 50% by weight, more preferably from 2% to 35% by weight, and most preferably from 5% to 25% by weight. When the content is less than 0.1% by weight, the charging capability, which is an expected function, may not be improved. When the content exceeds 50% by weight, the physical strength may deteriorate. When the content is within the above-described preferable range, it is advantageous in terms of charge retention capability.

### Other Components

The mother toner particle may further include other components, such as a colorant, a release agent, and a charge controlling agent.

### Colorant

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These materials can be used alone or in combination.

The colorant can be combined with a resin to be used as a master batch. Specific examples of usable resins for the master batch include, but are not limited to, homopolymers of styrene or styrene derivatives, styrene-based copolymers, polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. These materials can be used alone or in combination.

The content of the colorant in the toner is preferably from 1% to 15% by weight and more preferably from 3% to 10% by weight. When the content is less than 0.1% by weight, a sufficient image density may not be obtained. When the content exceeds 15% by weight, high-resolution and high-quality images may not be produced.

### Release Agent

Specific materials usable for the release agent include, but are not limited to, waxes. Specific examples of usable waxes include, but are not limited to, a carbonyl-group-containing wax, a polyolefin wax, and a long-chain hydrocarbon. These materials can be used alone or in combination. Among these waxes, a carbonyl-group-containing wax is preferable.

Specific examples of the carbonyl-group-containing wax include, but are not limited to, a polyalkanoic acid ester, a polyalkanol ester, a polyalkanoic acid amide, a polyalkyl amide, and a dialkyl ketone. Among these waxes, a polyalkanoic acid ester is preferable.

Specific examples of the polyalkanoic acid ester include, but are not limited to, carnauba wax, montan wax, trimethylolpropane tribehenate, pentaerythritol tetrabehenate, pentaerythritol diacetate dibehenate, glycerin tribehenate, and 1,18-octadecanediol distearate.

Specific examples of the polyalkanol ester include, but are not limited to, tristearyl trimellitate and distearyl maleate.

Specific examples of the polyalkanoic acid amide include, but are not limited to, dibehenylamide.

Specific examples of the polyalkyl amide include, but are not limited to, trimellitic acid tristearylamide.

Specific examples of the dialkyl ketone include, but are not limited to, distearyl ketone.

Specific examples of the polyolefin wax include, but are not limited to, a polyethylene wax and a polypropylene wax.

Specific examples of the long-chain hydrocarbon include, but are not limited to, a paraffin wax and a SAZOL wax.

The release agent preferably has a melting point of from 40 to 160° C., more preferably from 50 to 120° C., and most preferably from 60 to 90° C. When the melting point is less than 40° C., the release agent may adversely affect the heat-resistant storage stability. When the melting point exceeds 160° C., cold offset is likely to occur when the toner is fixed at a low temperature.

The release agent preferably has a melt-viscosity of from 5 to 1,000 cps, more preferably from 10 to 100 cps, when measured at a temperature 20° C. higher than the melting point. When the melt-viscosity is less than 5 cps, the releasability may deteriorate. When the melt-viscosity exceeds 1,000 cps, hot offset resistance and low-temperature fixability may not be improved.

The content of the release agent in the toner is preferably from 1% to 40% by weight and more preferably from 3% to 30% by weight. When the content of the release agent exceeds 40% by weight, the fluidity of the toner may deteriorate.

### Charge Controlling Agent

Specific examples of usable charge controlling agents include, but are not limited to, triphenylmethane dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives. These materials can be used alone or in combination.

Specific examples of commercially available charge controlling agents include, but are not limited to, BONTRON® P-51 (quaternary ammonium salt), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complexes of quaternary ammonium salts), which are manufactured by Hodogaya Chemical Co., Ltd.; LRA-901, and LR-147 (boron complex), which are manufactured by Japan Carlit Co., Ltd.; and quinacridone, azo pigments, and polymers having a functional group such as a sulfonate group, a carboxyl group, and a quaternary ammonium group.

The content of the charge controlling agent depends on the kind of the binder resin, existence or non-existence of an additive, and/or dispersing method, but is preferably from 0.1% to 10% by weight, more preferably from 0.2% to 5% by weight, based on the binder resin. When the content of the charge controlling agent is less than 0.1% by weight, the rapidly-charging property and charge amount are insufficient and the toner image may be adversely affected. When the content of charge controlling agent exceeds 10% by weight, the chargeability of the toner becomes too large and the electrostatic attractive force to the developing roller is too much increased, causing deterioration in the flowability of the developer and the image density.

### External Additive

The toner may further include an external additive.

Specific examples of the external additive include, but are not limited to, an oxide particle, an inorganic particle, a hydrophobized inorganic particle, and combinations thereof. A hydrophobized inorganic particle having a primary average particle diameter of from 1 to 100 nm, more preferably from 5 to 70 nm, is preferable.

The external additive preferably includes at least one kind of hydrophobized inorganic particle having a primary average particle diameter of 20 nm or less and at least one kind of hydrophobized inorganic particle having a primary average particle diameter of 30 nm or more. The external additive preferably has a BET specific surface area of from 20 to 500 m²/g.

Specific examples of the external additive include, but are not limited to, a silica particle, a hydrophobized silica, a metal salt of a fatty acid (e.g., zinc stearate, aluminum stearate), a metal oxide (e.g., titania, alumina, tin oxide, antimony oxide), and a fluoropolymer.

In particular, hydrophobized particles of silica, titania, titanium oxide, and alumina are preferably used as the external additive. Specific examples of the silica particle include, but are not limited to, R972, R974, RX200, RY200, R202, R805, and R812 (available from Nippon Aerosil Co., Ltd.). Specific examples of the titania particle include, but are not limited to, P-25 (available from Nippon Aerosil Co., Ltd.); STT-30 and STT-65C-S (available from Titan Kogyo, Ltd.); TAF-140 (available from Fuji Titanium Industry Co., Ltd.); and MT-150W, MT-500B, MT-600B, and MT-150A (available from Tayca Corporation).

Specific examples of the hydrophobized titanium oxide particle include, but are not limited to, T-805 (available from Nippon Aerosil Co., Ltd.); STT-30A and STT-65S-S (available from Titan Kogyo, Ltd.); TAF-500T and TAF-1500T (available from Fuji Titanium Industry Co., Ltd.); MT-100S and MT-100T (available from Tayca Corporation); and IT-S (available from Ishihara Sangyo Kaisha, Ltd.).

The hydrophobized oxide particle, hydrophobized silica particle, hydrophobized titania particle, and hydrophobized alumina particle can be obtained by treating hydrophobic particles thereof with a silane coupling agent such as methyl trimethoxysilane, methyl triethoxysilane, and octyl trimethoxysilane. In addition, a silicone-oil-treated oxide or inorganic particle, which is prepared by treating an oxide or inorganic particle with a silicone oil, by application of heat if needed, is also preferable.

Specific examples of the silicone oil include, but are not limited to, dimethyl silicone oil, methyl phenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, methacryl-modified silicone oil, and α-methylstyrene-modified silicone oil.

Specific examples of the inorganic particle include, but are not limited to, silica, alumina, titanium oxide, barium titanate, magnesium titanate, calcium titanate, strontium titanate, iron oxide, copper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Among these materials, silica and titanium dioxide are preferable.

The content of the external additive is preferably from 0.1% to 5% by weight and more preferably from 0.3% to 3% by weight based on the weight of the toner.

### Weight Average Molecular Weight

Weight average molecular weight can be measured by a gel permeation chromatographic measurement apparatus such as HLC-8220GPC (available from Tosoh Corporation) equipped with three-tandem columns TSKgel SuperHZM-H (available from Tosoh Corporation) having a length of 15 cm. A resin to be measured is dissolved in tetrahydrofuran (THF containing a stabilizer available from Wako Pure Chemical Industries, Ltd.) to prepare a 0.15% solution thereof. The solution is filtered with 0.2-μm filter and the filtrate is used as a sample. The sample in an amount of 100 μL is injected in the measurement apparatus and subjected to a measurement at a temperature of 40° C. and a flow rate of 0.45 mL/min. The molecular weight of the sample is calculated referring to a calibration curve compiled from several kinds of monodisperse polystyrene standard samples that shows the relation between the logarithmic value and the number of counts. The monodisperse polystyrene standard samples include Showdex STANDARD Std. No. S-7300, S-210, S-390, S-875, S-1980, S-10.9, S-629, S-3.0, and S-0.580 (available from Showa Denko K.K.) and toluene. As the detector, an RI (refractive index) detector is used. Volume Average Particle Diameter (Dv) and Number Average Particle Diameter (Dn)

The mother particle preferably has a volume average particle diameter (Dv) of from 3.0 to 6.0 μm and more preferably from 4.0 to 5.5 μm. When Dv is less than 3.0 μm, the adhesion force may excessively increase in practical use. When Dv exceeds 6.0 μm, the image quality may be adversely affected. When Dv is within the above-described preferable range, variation in charge among the toner particles is small, which is advantageous in terms of toner quality.

The ratio (Dv/Dn) of the volume average particle diameter (Dv) to the number average particle diameter (Dn) of the toner is preferably from 1.05 to 1.25 and more preferably from 1.06 to 1.20. When the ratio (Dv/Dn) is less than 1.05, the yield ratio may decrease. When the ratio (Dv/Dn) exceeds 1.25, the toner particles are excessively deformed to cause a practical problem in image quality. When the ratio (Dv/Dn) is within the above-described preferable range, it is advantageous in terms of charge and image quality.

### Measurement Method of Particle Size Distribution

The volume average particle diameter (Dv) and number average particle diameter (Dn) of the mother toner particle can be measured by an instrument such as COULTER COUNTER II or COULTER MULTISIZER II (available from Beckman Coulter, Inc.). In the present disclosure, a COULTER MULTISIZER II is used. The measurement method is as follows.

First, from 0.1 to 5 mL of a surfactant, preferably a polyoxyethylene alkyl ether (i.e., a nonionic surfactant), serving as a dispersing agent, is added to from 100 to 150 mL of an electrolyte. As the electrolyte, a 1% NaCl aqueous solution of the first grade sodium chloride, such as ISOTON-II (available from Beckman Coulter, Inc.), can be used. A sample in an amount of from 2 to 20 mg is then added thereto. The electrolyte in which the sample is suspended is subjected to a dispersion treatment by an ultrasonic disperser for about 1 to 3 minutes, and then subjected to a measurement of the volume and number of toner particles with the above-described instrument equipped with a 100-μm aperture to calculate the volume and number distributions. The volume average particle diameter (Dv) and number average particle diameter (Dn) of the sample are determined from the obtained volume and number distributions.

The following 13 channels are used: not less than 2.00 μm and less than 2.52 μm; not less than 2.52 μm and less than 3.17 μm; not less than 3.17 μm and less than 4.00 μm; not less than 4.00 μm and less than 5.04 μm; not less than 5.04 μm and less than 6.35 μm; not less than 6.35 μm and less than 8.00 μm; not less than 8.00 μm and less than 10.08 μm; not less than 10.08 μm and less than 12.70 μm; not less than 12.70 μm and less than 16.00 μm; not less than 16.00 μm and less than 20.20 μm; not less than 20.20 μm and less than 25.40 μm; not less than 25.40 μm and less than 32.00 μm; and not less than 32.00 μm and less than 40.30 μm. Particles having a particle diameter of not less than 2.00 μm and less than 40.30 μm are measurement targets.

### Production Method of Toner

The toner according to an embodiment of the present invention can be produced by various methods such as a pulverization method and a polymerization method.

### Pulverization Method

The pulverization method may include (1) a process of kneading a toner composition; (2) a process of pulverizing the kneaded toner composition; and (3) a process of classifying the pulverized particles by particle size.

The toner composition may contain the binder resin, the inorganic-layer-containing resin particle, and the colorant.

Kneaders usable in the kneading process include, but are not limited to, a closed kneader, a single-axis or double-axis extruder, and an open-roll kneader. Specific examples of commercially-available kneaders include, but are not limited to, KRC KNEADER (from Kurimoto, Ltd.); BUSS KOKNEADER (from Buss Corporation); TWIN SCREW COMPOUNDER TEM (from Toshiba Machine Co., Ltd.); TWIN SCREW EXTRUDER TEX (from The Japan Steel Works, Ltd.); TWIN SCREW EXTRUDER PCM (from Ikegai Co., Ltd.); THREE ROLL MILL, MIXING ROLL MILL, and KNEADER (from Inoue Mfg., Inc.); KNEADEX (from Nippon Coke & Engineering Company, Limited); MS TYPE DISPERSION MIXER and KNEADER-RUDER (from Moriyama), and BANBURY MIXER (from Kobe Steel, Ltd.).

Pulverizers usable in the pulverizing process are not limited to any particular apparatuses, and commercially-available pulverizers can be used. Specific examples of commercially-available pulverizers include, but are not limited to, COUNTER JET MILL, MICRON JET, and INOMIZER (from Hosokawa Micron Corporation); IDS-TYPE MILL and PJM JET MILL (from Nippon Pneumatic Mfg. Co., Ltd.); CROSS JET MILL (from Kurimoto, Ltd.); NSE-ULMAX (from Nisso Engineering Co., Ltd.); SK JET-O-MILL (from Seishin Enterprise Co., Ltd.); KRYPTRON (from Kawasaki Heavy Industries, Ltd.); TURBO MILL (from Freund-Turbo Corporation); and SUPER ROATER (from Nisshin Engineering Inc.).

Classifiers usable in the classifying process are not limited to any particular apparatuses, and commercially-available classifiers can be used. Specific examples of commercially-available classifiers include, but are not limited to, CLASSIEL, MICRON CLASSIFIER, and SPEDIC CLASSIFIER (from Seishin Enterprise Co., Ltd.); TURBO CLASSIFIER (from Nisshin Engineering Inc.); MICRON SEPARATOR, TURBOPLEX ATP, and TSP SEPARATOR (from Hosokawa Micron Corporation); ELBOW JET (from Nittetsu Mining Co., Ltd.); DISPERSION SEPARATOR (from Nippon Pneumatic Mfg. Co., Ltd.); and YM MICRO CUT (from Yaskawa & Co., Ltd.).

### Polymerization Method

A polymerization method which includes a process of dispersing an oily phase containing the binder resin, the inorganic-layer-containing resin particle, and optional colorant and release agent, in an aqueous medium, is preferable.

One example of such a toner production method includes a dissolution suspension method. Another example of such a toner production method includes a method of forming mother toner particles while extending a polyester resin by an elongation reaction and/or a cross-linking reaction of the prepolymer with the compound having an active hydrogen group. This method includes the processes of preparing an aqueous medium, preparing an oily phase containing toner materials, emulsifying or dispersing the toner materials, and removing an organic solvent.

### Preparation of Aqueous Medium

The aqueous medium is prepared by dispersing resin particles in an aqueous solvent.

Specific usable materials for the resin particles include, but are not limited to, vinyl resin, polyurethane resin, epoxy resin, and polyester resin.

The added amount of the resin particles is preferably from 0.5 to 10% parts by weight base on 100 parts by weight of the aqueous solvent.

Specific examples of the aqueous solvent include, but are not limited to, water, a water-miscible solvent, and a mixture thereof. These materials can be used alone or in combination. Among these materials, water is preferable.

Specific examples of the water-miscible solvent include, but are not limited to, an alcohol, dimethylformamide, tetrahydrofuran, a cellosolve, and a lower ketone. Specific examples of the alcohol include, but are not limited to, methanol, isopropanol, and ethylene glycol. Specific examples of the lower ketone include, but are not limited to, acetone and methyl ethyl ketone.

### Preparation of Oily Phase

The oily phase is prepared by dissolving or dispersing toner materials including at least the binder resin, the inorganic-layer-containing resin particle, and the prepolymer, and optionally the compound having an active hydrogen group, the release agent, and/or the colorant, in an organic solvent.

An organic solvent having a boiling point less than 150° C. is preferable because of being easily removable.

Specific examples of organic solvents having a boiling point less than 150° C. include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These materials can be used alone or in combination.

Among these solvents, ethyl acetate, toluene, xylene, benzene, methylene chloride, 1,2-dichloroethane, chloroform, and carbon tetrachloride are preferable, and ethyl acetate is most preferable.

### Emulsification and Dispersion

The oily phase containing the toner materials is dispersed in the aqueous medium to emulsify or disperse the toner materials therein. At the time of emulsification or dispersion of the toner materials, an elongation and/or cross-linking reaction of the compound having an active hydrogen group with the prepolymer is caused.

Reaction conditions (e.g., reaction time, reaction temperature) for producing the prepolymer depend on the combination of the compound having an active hydrogen group with the prepolymer and are not limited to any particular conditions.

The reaction time is preferably from 10 minutes to 40 hours and more preferably from 2 to 24 hours.

The reaction temperature is preferably from 0° C. to 150° C. and more preferably from 40° C. to 98° C.

A stable dispersion liquid can be prepared by dispersing the oily phase, prepared by dissolving or dispersing the toner materials in a solvent, in the aqueous medium by application of a shearing force.

Usable dispersers include, but are not limited to, a low-speed shearing disperser, a high-speed shearing disperser, a frictional disperser, a high-pressure jet disperser, and an ultrasonic disperser.

Among these dispersers, a high-speed shearing disperser is preferable because it is capable of adjusting the particle diameter of the dispersing elements (oil droplets) to from 2 to 20 μm.

When using the high-speed shearing dispersers, dispersing conditions, such as rotation number, dispersing time, and dispersing temperature, are determined depending on the intended use.

The rotation number is preferably from 1,000 to 30,000 rpm and more preferably form 5,000 rpm to 20,000 rpm.

The dispersing time is preferably from 0.1 to 5 minutes in the case of a batch-type disperser.

The dispersing temperature is preferably from 0° C. to 150° C. and more preferably from 40° C. to 98° C. Generally, the higher the dispersing temperature, the easier the dispersing.

The used amount of the aqueous medium at the time of emulsification or dispersion of the toner materials is preferably from 50 to 2,000 parts by weight, more preferably from 100 to 1,000 parts by weight, based on 100 parts by weight of the toner materials.

When the used amount of the aqueous medium is less than 50 parts by weight, the dispersion state of the toner materials may deteriorate and the resulting mother toner particles cannot have a desired particle diameter. When the used amount of the aqueous medium exceeds 2,000 parts by weight, the production cost may increase.

When the oily phase containing the toner materials are emulsified or dispersed in the aqueous medium, to stabilize the dispersing element (oil droplets) and make them have a desired shape and a narrow particle size distribution, a dispersant is preferably used.

Specific examples of the dispersant include, but are not limited to, a surfactant, a poorly-water-soluble inorganic compound, and a polymeric protection colloid. These materials can be used alone or in combination. Among these materials, a surfactant is preferable.

Specific examples of the surfactant include, but are not limited to, an anionic surfactant, a cationic surfactant, a nonionic surfactant, and an ampholytic surfactant.

Specific examples of the anionic surfactant include, but are not limited to, an alkylbenzene sulfonate, an α-olefin sulfonate, and a phosphate. Among these materials, those having a fluoroalkyl group are preferable.

### Removal of Organic Solvent

The organic solvent in the dispersion liquid (i.e., emulsion slurry) can be removed by gradually heating the whole reaction system to evaporate the organic solvent contained in the oil droplets or spraying the dispersion liquid into a dry atmosphere to remove the organic solvent contained in the oil droplets.

After the removal of the organic solvent, mother toner particles are obtained. The mother toner particles are washed, dried, and classified by size. The classification can be performed by means of cyclone separation, decantation, or centrifugal separation, to remove ultrafine particles. Alternatively, the classification can be performed after the mother toner particles are dried.

The mother toner particles can be mixed with the external additive particles. By applying a mechanical impulsive force at the time of mixing, the external additive particles are prevented from releasing from the surface of the mother toner particle.

A mechanical impulsive force can be applied to the mother toner particles by agitating the mother toner particles with blades rotating at a high speed, or accelerating the mother toner particles in a high-speed airflow to make them collide with each other or a collision plate.

Such a treatment can be performed by ONG MILL (from Hosokawa Micron Co., Ltd.), a modified I-TYPE MILL (from Nippon Pneumatic Mfg. Co., Ltd.) in which the pulverizing air pressure is reduced, HYBRIDIZATION SYSTEM (from Nara Machine Co., Ltd.), KRYPTON SYSTEM (from Kawasaki Heavy Industries, Ltd.), or an automatic mortar.

### Developer

In accordance with some embodiments of the present invention, a developer is provided. The developer includes the toner described above and optional components such as a carrier.

The developer has excellent transferability and chargeability and is capable of reliably forming high-quality image. The developer may be either a one-component developer or a two-component developer. When the developer is used for a high-speed printer in accordance with recent improvement in information processing speed, the developer is preferably used as a two-component developer owing to its long lifespan.

When the developer is used as a one-component developer, the average toner particle size may not vary very much although consumption and supply of the toner particles are repeated. Additionally, the toner particles may not adhere or fix to a developing roller or a toner layer regulating blade. Thus, stable developability and image quality are provided even after the developer is exposed to a long-term stirring in the developing device.

When the developer is used as a two-component developer, the average toner particle size may not vary very much although consumption and supply of the toner particles are repeated. Thus, stable developability and image quality are provided even after the developer is exposed to a long-term stirring in the developing device.

### Carrier

The carrier may be composed of a core material and a resin layer that covers the core material.

### Core Material

Specific materials usable for the core material include, but are not limited to, manganese-strontium materials having a magnetization of from 50 to 90 emu/g and manganese-magnesium materials having a magnetization of from 50 to 90 emu/g. To secure an image density, high magnetization materials such as iron powders having a magnetization of 100 emu/g or more and magnetites having a magnetization of from 75 to 120 emu/g are preferable. Low magnetization materials such as copper-zinc materials having a magnetization of from 30 to 80 emu/g are also preferable because they can adsorb the impact of the ear-like developer against the photoconductor, which is advantageous in terms of image quality.

These materials can be used alone or in combination.

The core material preferably has a volume average particle diameter of from 10 to 150 μm, more preferably from 40 to 100 μm. When the volume average particle diameter is less than 10 μm, it means that the resulting carrier particles include a relatively large amount of fine particles, and therefore the magnetization per carrier particle is low enough to cause carrier scattering. When the volume average particle diameter exceeds 150 μm, it means that the specific surface area of the carrier particle is low enough to cause toner scattering, and therefore solid portions in full-color images may not be reliably reproduced.

The toner can be mixed with the carrier to be used as a two-component developer. The content of the carrier in the two-component developer is preferably from 90 to 98 parts by weight, more preferably from 93 to 97 parts by weight, based on 100 parts by weight of the two-component developer.

The developer can be used for any electrophotographic image forming methods, such as magnetic one-component developing methods, non-magnetic one-component developing methods, and two-component developing methods.

### Developer Container

In accordance with some embodiments of the present invention, a developer container is provided. The developer container includes the developer described above and a container having a main body and a cap.

The main body is not limited in size, shape, structure, and material. Preferably, the main body has a cylindrical shape, and concavities and convexities are formed on the inner surface thereof in a spiral manner so that the content (developer) can migrate to the outlet side as it rotates. More preferably, a part or all of the concavities and convexities formed in a spiral manner provide an accordion function. Materials having a good dimension accuracy are preferably used, such as polyester resin, polyethylene resin, polypropylene resin, polystyrene resin, polyvinyl chloride resin, polyacrylic acid, polycarbonate resin, ABS resin, and polyacetal resin.

The developer container is easy to store, transport, and handle. The developer container can be detachably attachable to a process cartridge or image forming apparatus, to be described later, to supply the developer thereto.

### Image Forming Apparatus and Image Forming Method

The image forming apparatus according to an embodiment of the present invention includes at least an electrostatic latent image bearer, an electrostatic latent image forming device, and a developing device, and optionally other devices.

The image forming method according to an embodiment of the present invention includes at least an electrostatic latent image forming process and a developing process, and optionally other processes.

The image forming method is preferably performed by the image forming apparatus. The electrostatic latent image forming process is preferably performed by the electrostatic latent image forming device. The developing process is preferably performed by the developing device. The other processes are preferably performed by the other devices.

### Electrostatic Latent Image Bearer

The electrostatic latent image bearer is not limited in material, structure, and size. Specific usable materials include, but are not limited to, inorganic photoconductors such as amorphous silicon and selenium, and organic photoconductors such as polysilane and phthalopolymethyne. Among these materials, amorphous silicon is advantageous in terms of long lifespan.

Specific examples of the amorphous silicon include, but are not limited to, a photoconductor having a photoconductive layer composed of a-Si formed on a support by means of a deposition method such as a vacuum deposition method, a sputtering method, an ion plating method, a thermal CVD (chemical vapor deposition) method, an optical CVD method, or a plasma CVD method, while heating the support to from 50° C. to 400° C. Among these deposition methods, a plasma CVD method is preferable that forms an a-Si-deposited film on a support by decomposing a raw material gas by means of a direct-current, high-frequency, or microwave glow discharge.

The electrostatic latent image bearer is not limited in shape but preferably has a cylindrical shape. The electrostatic latent image bearer having a cylindrical shape preferably has an outer diameter of from 3 to 100 mm, more preferably from 5 to 50 mm, and most preferably from 10 to 30 mm.

### Electrostatic Latent Image Forming Device and Electrostatic Latent Image Forming Process

The electrostatic latent image forming device is not limited to any particular device so long as it forms an electrostatic latent image on the electrostatic latent image bearer. The electrostatic latent image forming device may include, for example, a charger for charging a surface of the electrostatic latent image bearer and an irradiator for irradiating the surface of the electrostatic latent image bearer with light containing image information.

The electrostatic latent image forming process is not limited to any particular process so long as it forms an electrostatic latent image on the electrostatic latent image bearer. The electrostatic latent image forming process may include, for example, charging a surface of the electrostatic latent image bearer and then irradiating the surface with light containing image information. The electrostatic latent image forming process can be performed by the electrostatic latent image forming device.

### Charger and Charging Process

Specific examples of the charger include, but are not limited to, a contact charger equipped with a conductive or semiconductive roller, brush, film, or rubber blade, and a non-contact charger such as corotron and scorotron that use corona discharge.

The charging process can be performed by applying a voltage to a surface of the electrostatic latent image bearer by the charger.

The charger may take the form of a roller, a magnetic brush, a fur brush, etc., depending on the specification or configuration of the image forming apparatus.

Preferably, the charger employs a contact charger because it reduces ozone generation.

### Irradiator and Irradiating Process

The irradiator is not limited to any particular device so long as it irradiates the surface of the electrostatic latent image bearer charged by the charger with light containing image information. Specific examples of the irradiator include, but are not limited to, a radiation optical irradiator, a rod lens array irradiator, a laser optical irradiator, and a liquid crystal shutter optical irradiator.

Specific examples of the light source for use in the irradiator include, but are not limited to, all luminous matters such as a fluorescent lamp, a tungsten lamp, a halogen lamp, a mercury lamp, a sodium-vapor lamp, a light-emitting diode (LED), a laser diode (LD), and an electroluminescence (EL).

To emit light having a desired wavelength, a filter can be used. Specific examples of the filter include, but are not limited to, a sharp cut filter, a band-pass filter, a near infrared cut filter, a dichroic filter, an interference filter, and a color temperature conversion filter.

The irradiating process can be performed by irradiating the surface of the electrostatic latent image bearer with light containing image information by the irradiator.

The irradiating process can also be performed by irradiating the back surface of the electrostatic latent image bearer with light containing image information.

### Developing Device and Developing Process

The developing device is not limited to any particular device so long as it contains a toner for developing the electrostatic latent image formed on the electrostatic latent image bearer into a visible image.

The developing process is not limited to any particular process so long as it develops the electrostatic latent image formed on the electrostatic latent image bearer into a visible image with a toner. The developing process can be performed by the developing device.

The developing device may employ either a dry developing method or a wet developing method. The developing device may employ either a single-color developing device or a multi-color developing device.

Preferably, the developing device includes a stirrer for stirring the toner to frictionally charge it, an internal magnetic field generator, and a rotatable developer bearer for bearing a developer including the toner.

In the developing device, the toner particles and carrier particles are mixed and stirred so that the toner particles are frictionally charged. The charged toner particles and carrier particles are borne on the surface of the magnet roller forming chain-like aggregations (hereinafter “magnetic brush”). The magnet roller is disposed near the electrostatic latent image bearer. Therefore, a part of the toner particles forming the magnetic brush migrates from the surface of the magnet roller to the surface of the electrostatic latent image bearer owing to an electrical attractive force. As a result, the electrostatic latent image formed on the electrostatic latent image bearer is developed into a toner image.

### Other Devices and Processes

The other devices to be optionally included may be, for example, a transfer device, a fixing device, a cleaner, a neutralizer, a recycler, and/or a controller.

The other processes to be optionally included may be, for example, a transfer process, a fixing process, a cleaning process, a neutralization process, a recycle process, and/or a control process.

### Transfer Device and Transfer Process

The transfer device is not limited to any particular device so long as it transfers the visible image onto a recording medium. Preferably, the transfer device includes a primary transfer device for transferring the visible image onto an intermediate transfer medium to form a composite transfer image, and a secondary transfer device for transferring the composite transfer image onto a recording medium.

The transfer process is not limited to any particular process so long as it transfers the visible image onto a recording medium. Preferably, the transfer process includes primarily transferring the visible image onto an intermediate transfer medium and secondarily transferring the visible image onto a recording medium.

The transfer process can be performed by transferring the visible image by charging the photoconductor by a transfer charger. The transfer process can be performed by the transfer device.

When the image to be secondarily transferred onto the recording medium is a color image composed of multiple toners having different colors, each color toner image is sequentially superimposed on one another on the intermediate transfer medium to form a composite image thereon, and then the composite image is secondarily transferred from the intermediate transfer medium onto the recording medium.

Specific examples of the intermediate transfer medium include, but are not limited to, a transfer belt.

Preferably, the transfer device (the primary transfer device, the secondary transfer device) includes a transferrer for charging the visible image to detach it from the photoconductor toward the recording medium. Specific examples of the transferrer include, but are not limited to, a corona transferrer employing corona discharge, a transfer belt, a transfer roller, a pressure transfer roller, and an adhesive transferrer.

The recording medium is not limited to any particular material so long as it receives an unfixed image. Specific examples of the recording medium include, but are not limited to, normal paper and PET base for use in OHP.

### Fixing Device and Fixing Process

The fixing device is not limited to any particular device so long as it fixes the transfer image on the recording medium. Specific examples of the fixing device include, but are not limited to, a heat-pressure member. Specific examples of the heat-pressure member include, but are not limited to, a combination of a heat roller and a pressure roller, and a combination of a heat roller, a pressure roller, and an endless belt.

The fixing process is not limited to any particular process so long as it fixes the transferred visible image on the recording medium. The fixing process can be performed every time each color toner image is transferred onto the recording medium. Alternatively, the fixing process can be performed only once when the composite toner image, in which each color toner image is superimposed on one another, is transferred onto the recording medium.

The fixing process can be performed by the fixing device.

The heating temperature of the heat-pressure member is preferably from 80 to 200° C. If needed, an optical fixer can be used in combination with or in place of the fixing device.

The surface pressure in the fixing process is preferably from 10 to 80 N/cm².

### Cleaner and Cleaning Process

The cleaner is not limited to any particular device so long as it removes toner particles remaining on the photoconductor. Specific examples of the cleaner include, but are not limited to, a magnetic brush cleaner, an electrostatic brush cleaner, a magnetic roller cleaner, a blade cleaner, a brush cleaner, and a web cleaner.

The cleaning process is not limited to any particular process so long as it removes toner particles remaining on the photoconductor. The cleaning process can be performed by the cleaner.

### Neutralizer and Neutralization Process

The neutralizer is not limited to any particular device so long as it neutralizes the photoconductor by applying a neutralization bias thereto. Specific examples of the neutralizer include, but are not limited to, a neutralization lamp.

The neutralization process is not limited to any particular process so long as it neutralizes the photoconductor by applying a neutralization bias thereto. The neutralization process can be performed by the neutralizer.

### Recycler and Recycle Process

The recycler is not limited to any particular device so long as it recycles the toner particles removed in the cleaning process by supplying them to the developing device. Specific examples of the recycler include, but are not limited to, a conveyer.

The recycle process is not limited to any particular process so long as it recycles the toner particles removed in the cleaning process by supplying them to the developing device. The recycle process can be performed by the recycler.

### Controller and Control Process

The controller is not limited to any particular device so long as it controls each of the above-described devices. Specific examples of the controller include, but are not limited to, a sequencer and a computer.

The control process is not limited to any particular process so long as it controls each of the above-described processes. The control process can be performed by the controller.

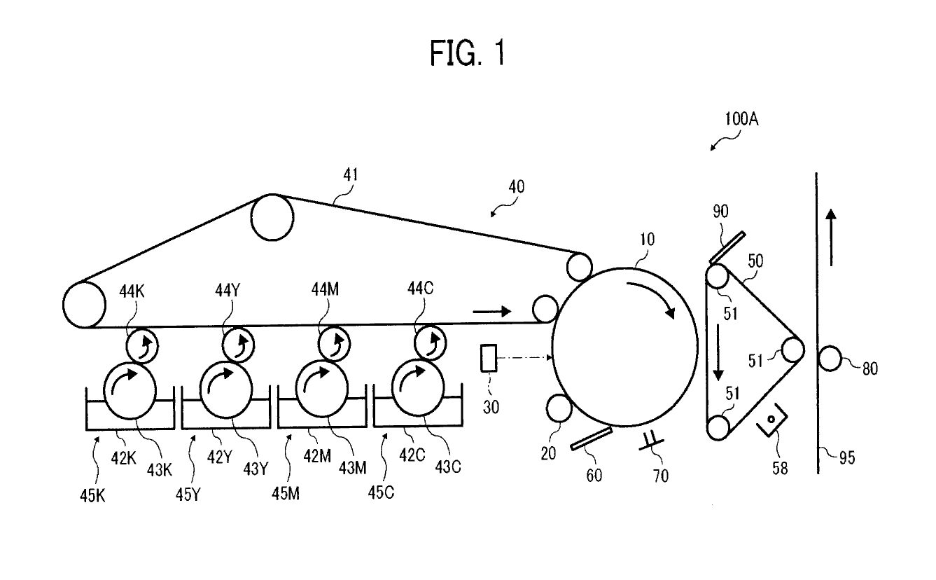

An image forming method using the image forming apparatus according to an embodiment of the present invention is described below with reference to FIG. 1. In FIG. 1, an image forming apparatus 100A includes a photoconductor drum 10 (hereinafter “photoconductor 10”) serving as the electrostatic latent image bearer, a charging roller 20 serving as the charger, an irradiator 30 serving as the irradiator, a developing device 40 serving as the developing device, an intermediate transfer medium 50, a cleaner 60 having a cleaning blade serving as the cleaner, and a neutralization lamp 70 serving as the neutralizer.

The intermediate transfer medium 50 is a seamless belt stretched taut with three rollers 51 disposed within the inner loop thereof. The intermediate transfer medium 50 is movable in a direction indicated by an arrow in FIG. 1. A part of the three rollers 51 functions as a transfer bias roller capable of applying a predetermined transfer bias (i.e., a primary transfer bias) to the intermediate transfer medium 50. A cleaner 90 having a cleaning blade is disposed adjacent to the intermediate transfer medium 50. A transfer roller 80 is disposed facing the intermediate transfer medium 50. The transfer roller 80, serving as the transfer device, is capable of applying a secondary transfer bias for transferring a toner image onto a transfer paper 95 serving as the recoding medium. A corona charger 58 is disposed facing the intermediate transfer medium 50 between the contact points of the intermediate transfer medium 50 with the photoconductor 10 and the recording medium 95 with respect to the direction of rotation of the intermediate transfer medium 50. The corona charger 58 gives charge to the toner image on the intermediate transfer medium 50.

The developing device 40 includes a developing belt 41 serving as the developer bearer; and a black developing unit 45K, an yellow developing unit 45Y, a magenta developing unit 45M, and a cyan developing unit 45C each disposed around the developing belt 41. The black developing unit 45K includes a developer container 42K, a developer supply roller 43K, and a developing roller 44K. The yellow developing unit 45Y includes a developer container 42Y, a developer supply roller 43Y, and a developing roller 44Y. The magenta developing unit 45M includes a developer container 42M, a developer supply roller 43M, and a developing roller 44M. The cyan developing unit 45C includes a developer container 42C, a developer supply roller 43C, and a developing roller 44C. The developing belt 41 is a seamless belt stretched taut with multiple belt rollers to be rotatable. A part of the developing belt 41 is in contact with the electrostatic latent image bearer 10.

In the image forming apparatus 100A, the charging roller 20 uniformly charges the photoconductor 10. The irradiator 30 irradiates the photoconductor 10 with light containing image information to form an electrostatic latent image thereon. The developing device 40 supplies toner to the electrostatic latent image formed on the photoconductor 10 to form a toner image. The toner image is primarily transferred onto the intermediate transfer medium 50 by a voltage applied from the roller 51 and is secondarily transferred onto the transfer paper 95. As a result, a transferred image is formed on the transfer paper 95. Residual toner particles remaining on the photoconductor 10 are removed by the cleaner 60. The photoconductor 10 is neutralized by the neutralization lamp 70.

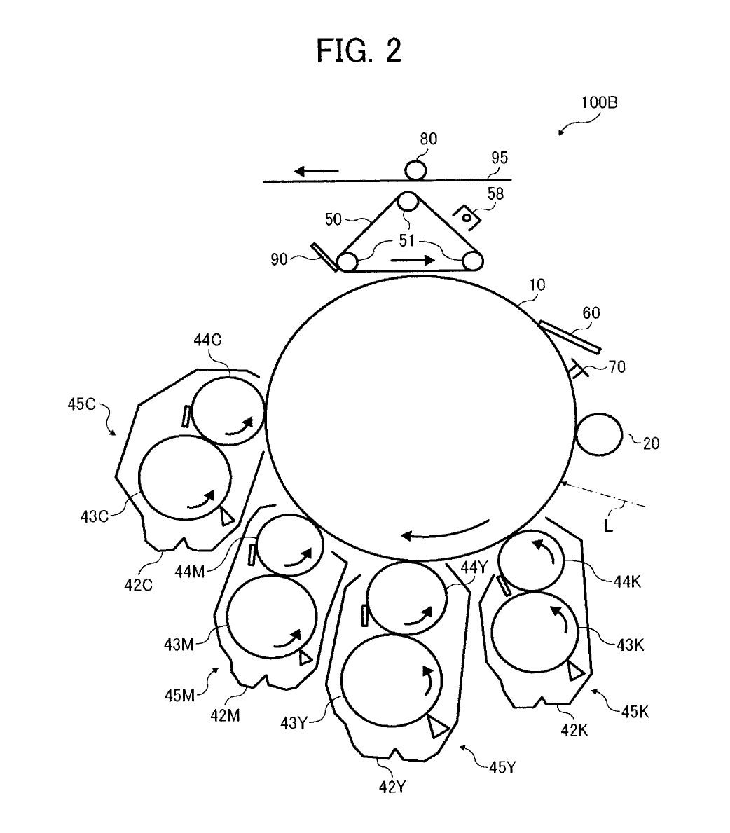

FIG. 2 is a schematic view of an image forming apparatus according to an embodiment of the present invention. An image forming apparatus 100B illustrated in FIG. 2 has the same configuration as the image forming apparatus 100A illustrated in 100A except that the developing belt 41 is not provided and the black developing unit 45K, the yellow developing unit 45Y, the magenta developing unit 45M, and the cyan developing unit 45C are disposed directly facing the photoconductor 10.

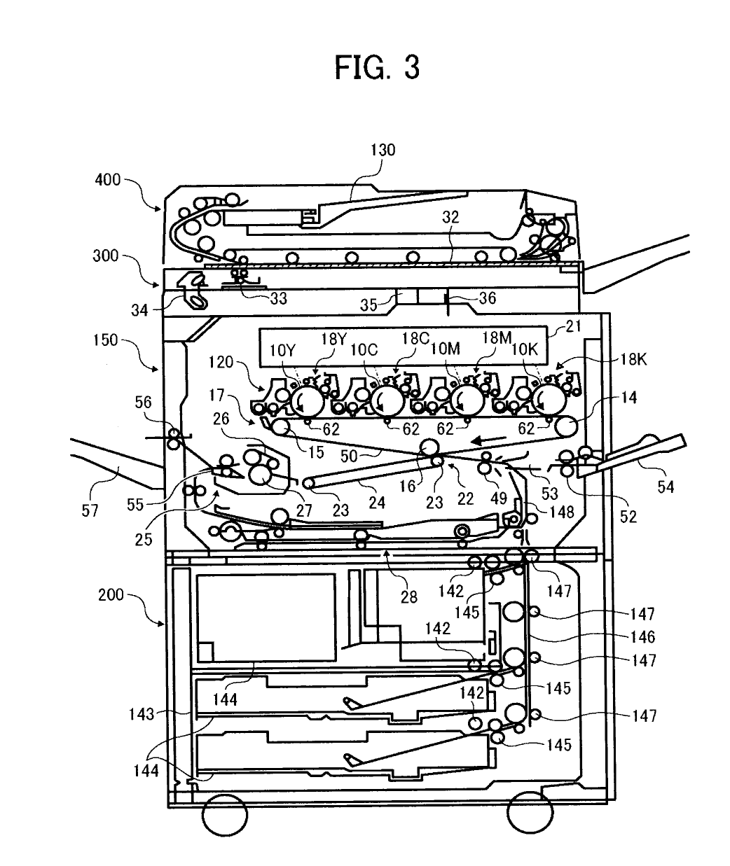

FIG. 3 is a schematic view of an image forming apparatus according to an embodiment of the present invention. An image forming apparatus illustrated in FIG. 3 includes a main body 150, a paper feeding table 200, a scanner 300, and an automatic document feeder (ADF) 400.

At the center of the main body 150, an intermediate transfer medium 50 in the form of a seamless belt is disposed. The intermediate transfer medium 50 is stretched taut with support rollers 14, 15, and 16 and is rotatable clockwise in FIG. 3. A cleaner 17 is disposed adjacent to the support roller 15. The cleaner 17 removes residual toner particles remaining on the intermediate transfer medium 50. Four image forming units 18Y, 18C, 18M, and 18K (hereinafter collectively the “image forming units 18”) to form respective toner images of yellow, cyan, magenta, and cyan are disposed in tandem facing a surface of the intermediate transfer medium 50 stretched between the support rollers 14 and 15. The image forming units 18 are formed into a tandem developing device 120. An irradiator 21 is disposed adjacent to the tandem developing device 120. A secondary transfer device 22 is disposed on the opposite side of the tandem developing device 120 with respect to the intermediate transfer medium 50. The secondary transfer device 22 includes a secondary transfer belt 24 in the form of a seamless belt stretched taut with a pair of rollers 23. A transfer paper conveyed by the secondary transfer belt 24 is brought into contact with the intermediate transfer medium 50. A fixing device 25 is disposed adjacent to the secondary transfer device 22. The fixing device 25 includes a fixing belt 26 in the form of a seamless belt and a pressing roller 27 pressed against the fixing belt 26.

A sheet reversing device 28 to reverse a sheet of transfer paper in duplexing is disposed adjacent to the secondary transfer device 22 and the fixing device 25.

In the tandem developing device 120, a full-color image is produced in the manner described below. A document is set on a document table 130 of the automatic document feeder 400. Alternatively, a document is set on a contact glass 32 of the scanner 300 while lifting up the automatic document feeder 400, followed by holding down of the automatic document feeder 400.

As a switch is pressed, in a case in which a document is set on the contact glass 32, the scanner 300 immediately starts driving, and in a case in which a document is set on the automatic document feeder 400, the scanner 300 starts driving after the document is fed onto the contact glass 32, so that a first runner 33 and a second runner 34 start moving. The first runner 33 directs light emitted from a light source to the document. A mirror in the second runner 34 reflects a light reflected from the document toward a reading sensor 36 through an imaging lens 35. Thus, the document is converted into image information of black, magenta, cyan, and yellow.

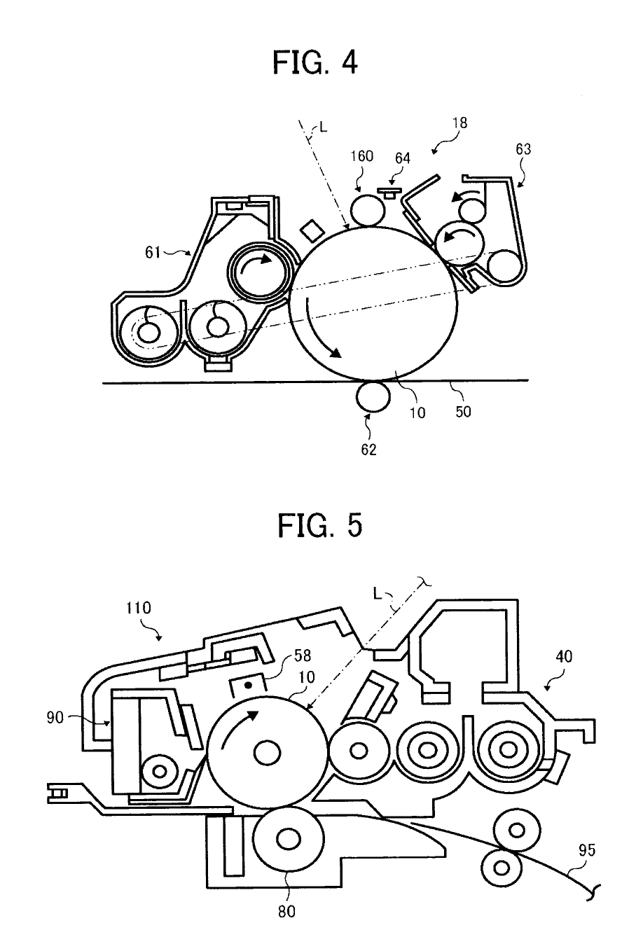

The image information of yellow, cyan, magenta, and black are respectively transmitted to the image forming units 18Y, 18C, 18M, and 18K. The image forming units 18Y, 18C, 18M, and 18K form respective toner images of yellow, cyan, magenta, and black. As illustrated in FIG. 4, each of the image forming units 18 includes a photoconductor 10, a charger 160 for uniformly charging the photoconductor 10, an irradiator for irradiating the charged surface of the photoconductor 10 with light L containing image information to form an electrostatic latent image, a developing device 61 for developing the electrostatic latent image into a toner image, a transfer charger 62 for transferring the toner image onto the intermediate transfer medium 50, a cleaner 63, and a neutralization lamp 64. Each of the image forming units 18 is capable of forming each single-color toner image (i.e., a black toner image, an yellow toner image, a magenta toner image, a cyan toner image) based on image information of each color. The toner images of yellow, cyan, magenta, and black are sequentially and primarily transferred from the respective photoconductors 10Y, 10M, 10C, and 10K onto the intermediate transfer medium 50 that is rotatably moved by the support rollers 14, 15, and 16. Thus, the toner images of yellow, cyan, magenta, and black are superimposed on one another on the intermediate transfer medium 50, thus forming a composite full-color toner image.

On the other hand, as the switch is pressed, one of paper feeding rollers 142 starts rotating in the paper feeding table 200 so that a sheet of a recording medium is fed from one of paper feeding cassettes 144 in a paper bank 143. The sheet is separated by one of separation rollers 145 and fed to a paper feeding path 146. Feed rollers 147 feed the sheet to a paper feeding path 148 in the main body 150. The sheet is then stopped by a registration roller 49. Alternatively, a recording medium may be fed from a manual feeding tray 54. In this case, a separation roller 52 separates the recording medium sheet by sheet and feeds it to a manual paper feeding path 53. The sheet is then stopped by the registration roller 49. The registration roller 49 is generally grounded. Alternatively, the registration roller 49 can be applied with a bias for the purpose of removing paper powders from the sheet. The registration roller 49 feeds the sheet to the gap between the intermediate transfer medium 50 and the secondary transfer belt 24 in synchronization with an entry of the composite full-color toner image formed on the intermediate transfer medium 50 into the gap. Thus, the composite full-color toner image is transferred onto the sheet. After the composite toner image is transferred, residual toner particles remaining on the intermediate transfer medium 50 are removed by the cleaner 17.

The sheet having the composite toner image thereon is fed from the secondary transfer device 22 to the fixing device 25. The fixing device 25 fixes the composite toner image on the sheet by application of heat and/or pressure. The switch claw 55 switches paper feeding paths so that the sheet is discharged by a discharge roller 56 to be stacked on the discharge tray 57. Alternatively, the switch claw 55 switches paper feeding paths so that the sheet gets reversed in the sheet reversing device 28 and is fed to the transfer position again. After another toner image is formed on the back side of the sheet, the sheet is discharged onto the discharge tray 57 by rotation of a discharge roller 56.

### Process Cartridge

A process cartridge according to an embodiment of the present invention is configured to be detachably mountable on an image forming apparatus. The process cartridge includes at least an electrostatic latent image bearer for bearing an electrostatic latent image and a developing device for developing the electrostatic latent image into a toner image with the developer according to an embodiment of the present invention. The process cartridge may further include other devices, if needed.

The developing device includes at least a developer container for containing the developer according to an embodiment of the present invention and a developer bearer for bearing and conveying the developer contained in the developer container. The developing device may further include a regulator for regulating the thickness of a developer layer on the developer bearer.

FIG. 5 is a schematic view of a process cartridge according to an embodiment of the present invention. A process cartridge 110 includes a photoconductor drum 10, a corona charger 58, a developing device 40, a transfer roller 80, and a cleaning device 90.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Example 1

### Preparation of Developer

### Preparation of Resin Particle Dispersion Liquid

A reaction vessel equipped with a stirrer and a thermometer is charged with 683 parts of water, 11 parts of a sodium salt of a sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. The mixture is stirred for 15 minutes at a revolution of 400 rpm, thus preparing a white emulsion. The white emulsion is heated to 75° C. and subjected to a reaction for 5 hours. A 1% aqueous solution of ammonium persulfate in an amount of 30 parts is further added to the emulsion, and the mixture is aged for 5 hours at 75° C. Thus, a resin particle dispersion liquid 1 that is an aqueous dispersion liquid of a vinyl resin (i.e., a copolymer of styrene, methacrylic acid, butyl acrylate, and a sodium salt of a sulfate of ethylene oxide adduct of methacrylic acid) is prepared. The resin particles in the resin particle dispersion liquid 1 have a weight average particle diameter of 105 nm when measured by a laser diffraction particle size distribution analyzer LA-920 (from Horiba, Ltd.). A part of the resin particle dispersion liquid 1 is dried to isolate the resin content. The resin content has a Tg of 59° C. and a weight average molecular weight of 150,000.

### Preparation of Aqueous Phase

An aqueous phase 1 is prepared by mixing and stirring 990 parts of water, 83 parts of the resin particle dispersion liquid 1, 37 parts of a 48.5% aqueous solution of dodecyl diphenyl ether sodium disulfonate (ELEMINOL MON-7 from Sanyo Chemical Industries, Ltd.), and 90 parts of ethyl acetate. The aqueous phase 1 is a milky whitish liquid.

### Preparation of Low-Molecular-Weight Polyester

A reaction vessel equipped with a condenser, a stirrer, and a nitrogen inlet pipe is charged with 229 parts of ethylene oxide 2 mol adduct of bisphenol A, 529 parts of propylene oxide 3 mol adduct of bisphenol A, 208 parts of terephthalic acid, 46 parts of adipic acid, and 2 parts of dibutyltin oxide. The mixture is subjected to a reaction for 8 hours at 230° C. under normal pressure, and subsequent 5 hours at reduced pressures of from 10 to 15 mmHg. After adding 44 parts of trimellitic anhydride, the mixture is further subjected to a reaction for 2 hours at 180° C. under normal pressure. Thus, a low-molecular-weight polyester 1 is prepared. The low-molecular-weight polyester 1 has a number average molecular weight of 2,500, a weight average molecular weight of 6,700, a glass transition temperature (Tg) of 43° C., and an acid value of 25 mgKOH/g.

### Preparation of Intermediate Polyester and Prepolymer

A reaction vessel equipped with a condenser, a stirrer, and a nitrogen inlet pipe is charged with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. The mixture is subjected to a reaction for 8 hours at 230° C. under normal pressure and subsequent 5 hours under reduced pressures of from 10 to 15 mmHg. Thus, an intermediate polyester 1 is prepared. The intermediate polyester 1 has a number average molecular weight of 2,100, a weight average molecular weight of 9,500, a glass transition temperature (Tg) of 55° C., an acid value of 0.5 mgKOH/g, and a hydroxyl value of 51 mgKOH/g.

Another reaction vessel equipped with a condenser, a stirrer, and a nitrogen inlet pipe is charged with 410 parts of the intermediate polyester 1, 89 parts of isophorone diisocyanate, and 500 parts of ethyl acetate. The mixture is subjected to a reaction for 5 hours at 100° C. Thus, a prepolymer 1 is prepared. The prepolymer 1 includes 1.53% of free isocyanates.

### Preparation of Ketimine Compound

A reaction vessel equipped with a stirrer and a thermometer is charged with 170 parts of isophoronediamine and 75 parts of methyl ethyl ketone. The mixture is subjected to a reaction for 5 hours at 50° C. Thus, a ketimine compound 1 is prepared. The ketimine compound 1 has an amine value of 418 mgKOH/g.

### Preparation of Master Batch

First, 35 parts of water, 40 parts of a phthalocyanine pigment FG7351 (from Toyo Ink Co., Ltd.), and 60 parts of a polyester resin RS801 (from Sanyo Chemical Industries, Ltd.) are mixed using a HENSCHEL MIXER (from Nippon Coke & Engineering Co., Ltd.). The resulting mixture is kneaded for 30 minutes at 150° C. using a double roll, the kneaded mixture is then rolled and cooled, and the rolled mixture is then pulverized into particles using a pulverizer. Thus, a master batch 1 is prepared.

### Preparation of Oily Phase

A reaction vessel equipped with a stirrer and a thermometer is charged with 378 parts of the low-molecular-weight polyester 1, 110 parts of a carnauba wax (from Toa Kasei Co., Ltd.), 22 parts of a charge controlling agent (a salicylic acid metal complex E-84 from Orient Chemical Industries Co., Ltd.), and 947 parts of ethyl acetate. The mixture is heated to 80° C. while being stirred, kept at 80° C. for 5 hours, and cooled to 30° C. over a period of 1 hour. The mixture is further mixed with 500 parts of the master batch 1 and 500 parts of ethyl acetate for 1 hour. Thus, a raw material liquid 1 is prepared.

### Preparation of Inorganic-Layer-Containing Resin Particle

A 2,000-ml four-necked flask equipped with a thermometer, a nitrogen inlet pipe, and a stirrer is charged with 5.0 g of a PMMA particle (MP-300 from Soken Chemical & Engineering Co., Ltd.) and 886.9 g of distilled water. The air in the flask is replaced with nitrogen gas. After adjusting the temperature of the reaction system to 25° C., 0.66 g of tetramethoxysilane (including 0.12 g of silicon atoms) is added while stirring the reaction system. The mixture is subjected to a reaction for 24 hours at 25° C. and subsequent 6 hours at 70° C. Thus, an aqueous solution of PMMA particles having a silica layer on their surfaces is prepared. The aqueous solution is filtered under reduced pressures. The filtered cake is dried by a circulating air dryer at 45° C. for 24 hours and then sieved with a mesh having openings of 25 μm so that coarse particles are removed and soft aggregations are loosen. Thus, an inorganic-layer-containing resin particle AA, having a silica layer on the surface, is prepared.

### Preparation of Dispersion Liquid of Inorganic-Layer-Containing Resin Particle AA and Wax

First, 1,324 parts of the raw material liquid 1 and 0.3 parts of the inorganic-layer-containing resin particle AA are contained in a container and subjected to a dispersion treatment using a bead mill (ULTRAVISCOMILL (trademark) from Aimex Co., Ltd.) filled with 80% by volume of zirconia beads having a diameter of 0.5 mm at a liquid feeding speed of 1 kg/hour and a disc peripheral speed of 6 m/sec. This dispersing operation is repeated 3 times (3 passes) to disperse the inorganic-layer-containing resin particle AA and the wax. Further, 1,324 parts of a 65% ethyl acetate solution of the low-molecular-weight polyester 1 are added, and the resulting mixture is subjected to the above dispersing operation for 1 time (1 pass). Thus, a dispersion liquid 1 of the inorganic-layer-containing resin particle AA and the wax is prepared. The dispersion liquid 1 of the inorganic-layer-containing resin particle AA and the wax has a solid content concentration of 50% (when measured at 130° C. for 30 minutes).

### Emulsification

In a vessel, 648 parts of the dispersion liquid 1 of the inorganic-layer-containing resin particle AA and the wax, 154 parts of the prepolymer 1, and 6.6 parts of the ketimine compound 1 are mixed for 1 minute at a revolution of 5,000 rpm using a TK HOMOMIXER (from Primix Corporation). After adding 1,200 parts of the aqueous phase 1 to the vessel, the resulting mixture is further mixed for 20 minutes at a revolution of 13,000 rpm using the TK HOMOMIXER. Thus, an emulsion slurry 1 is obtained.

### Shape Control

SEROGEN BS-H (from Dai-ichi Kogyo Seiyaku Co., Ltd.) in an amount of 3.15 parts is gradually added to 75.6 parts of ion-exchange water being stirred at a revolution of 2,000 rpm by a TK HOMOMIXER (from Primix Corporation). The mixture is stirred for 30 minutes while being kept at 20° C. Thus, a SEROGEN solution is prepared. The resulting SEROGEN solution is mixed with 43.3 parts of a 48.5% aqueous solution of dodecyl diphenyl ether sodium disulfonate (ELEMINOL MON-7 from Sanyo Chemical Industries, Ltd.). The mixture is stirred for 5 minutes while being kept at 20° C. The emulsion slurry 1 in an amount of 2,000 parts is further mixed therein by a TK HOMOMIXER at a revolution of 2,000 rpm for 1 hour. Thus, a shape control slurry 1 is prepared.

### Solvent Removal

The shape control slurry 1 is contained in a vessel equipped with a stirrer and a thermometer and subjected to solvent removal for 8 hours at 30° C. and subsequent aging for 4 hours at 45° C. Thus, a dispersion slurry 1 is prepared.

### Washing and Drying

After filtering 100 parts of the dispersion slurry 1 under reduced pressures:

(1) The filter cake is mixed with 100 parts of ion-exchange water using a TK HOMOMIXER for 10 minutes at a revolution of 12,000 rpm, followed by filtering;
(2) The filter cake of (1) is mixed with 100 parts of a 10% aqueous solution of sodium hydroxide by a TK HOMOMIXER at a revolution of 12,000 rpm for 30 minutes, followed by filtering under reduced pressures;
(3) The filter cake of (2) is mixed with 100 parts of a 10% hydrochloric acid by a TK HOMOMIXER at a revolution of 12,000 rpm for 10 minutes, followed by filtering; and
(4) The filter cake of (3) is mixed with 300 parts of ion-exchange water using a TK HOMOMIXER for 10 minutes at a revolution of 12,000 rpm, followed by filtering. This operation is repeated twice. Thus, a filter cake 1 is obtained.

The filter cake 1 is dried by a circulating air dryer for 48 hours at 45° C. and sieved with a mesh having openings of 75 μm. Thus, a mother particle AA is prepared.

### Addition of External Additive

First, 100 parts of the mother toner particle AA and 0.75 parts of a hydrophobized rutile-type titanium oxide (MT-150AI from Tayca Corporation) having an average particle diameter of 15 nm are mixed by a HENSCHEL MIXER while setting the peripheral speed of agitation blades to 35 m/sec. Next, 0.8 parts of a hexamethyldisilazane-treated hydrophobized silica having an average particle diameter of 8 nm are mixed therein by a HENSCHEL MIXER while setting the peripheral speed of agitation blades to 35 m/sec. The resulting toner particles, covered with the external additives, are sieved with a mesh having openings of 25 μm so that coarse particles produced in the above processes are removed. Thus, a toner AA having external additives is obtained.

### Preparation of Developer

A coating liquid is prepared by dispersing 3 parts of a carbon black (KETJENBLACK EC-DJ600 from LION AKZO Co., Ltd.) in toluene. A carrier is prepared by applying 200 parts of a silicone resin solution (SR2411 from Dow Corning Toray Co., Ltd.) and the coating liquid to 2,500 parts of a ferrite core material (Cu—Zn ferrite having a magnetization at 1 KOe of 58 emu/g and a bulk density of 2.43 g/cm³) by a fluidized-bed spraying method, and then burning the surface-covered ferrite material in an electric furnace at 300° C. for 2 hours. The resulting carrier has a relatively narrow particle diameter distribution and an average particle diameter of from 30 to 60 μm.

A developer is prepared by mixing and stirring 0.9 parts of the toner AA 0.9 parts having the external additives and 12 parts of the carrier.

### Example 2

The procedure in Example 1 is repeated except for replacing the PMMA particle (MP-300 from Soken Chemical & Engineering Co., Ltd.) with another PMMA particle (MX-80H3wT from Soken Chemical & Engineering Co., Ltd.), thus obtaining an inorganic-layer-containing resin particle AB.

### Example 3

### Preparation of Developer by Pulverization Method

A binder resin (i.e., a bisphenol-type polyester resin composed primarily of ethylene oxide adduct of bisphenol A and terephthalic acid, having a weight average molecular weight of 1.1×10⁴, a number average molecular weight of 3.9×10³, a melt viscosity (η) of 90 Pa s at 140° C., and a glass transition temperature (Tg) of 69° C.) in an amount of 100 parts, a high-melt-viscosity resin (i.e., a terpene-modified novolac resin, having a weight average molecular weight of 2,500, a melting point (Tm) of 165° C., and a melt viscosity (η) of 85,000 Pa·s at 140° C.) in an amount of 20 parts, a carbon black (BPL from Cabot Corporation) in an amount of 5 parts, a charge controlling agent (BONTRON E84 from Orient Chemical Industries Co., Ltd.) in amount of 2 parts, the inorganic-layer-containing resin particle AA in an amount of 5 parts, and a low-molecular-weight polypropylene (VISCOL 660P from Sanyo Chemical industries, Ltd.) in an amount of 5 parts are poured in an air-cooled double roll mill. The mixture is melt-kneaded for 15 minutes, followed by cooling. The cooled mixture is pulverized into fine particles by a jet mill, and the fine particles are classified by size by a wind-power classifier. Thus, a mother toner particle BA having a volume average particle diameter of 6 μm is prepared.

The procedures for adding external additives and mixing with the carrier in Example 1 are repeated expect for replacing the mother toner particle AA with the mother toner particle BA.

### Example 4

The procedure in Example 3 is repeated except for replacing the inorganic-layer-containing resin particle AA with the inorganic-layer-containing resin particle AB.

### Comparative Example 1

The procedure in Example 1 is repeated except that the inorganic-layer-containing resin particle AA is not added.

### Comparative Example 2

The procedure in Example 3 is repeated except that the inorganic-layer-containing resin particle AA is not added.

### Image Forming Apparatus

The above-prepared toners are evaluated with an image forming apparatus described below.

The image forming apparatus includes a photoconductor drum serving as an image bearer; a charging roller for uniformly charging the photoconductor drum in proximity to or in contact with the photoconductor drum; an irradiator for forming an electrostatic latent image on the photoconductor drum; a developing device for developing the electrostatic latent image into a toner image; a transfer belt for transferring the toner image onto a transfer paper; a cleaner for removing residual toner particles remaining on the photoconductor drum; a neutralization lamp for neutralizing residual charge remaining on the photoconductor drum; and an optical sensor for controlling the voltage which is applied by the charging roller and the toner concentration in the developer. The developing device is supplied with each Example or Comparative Example toner from a toner supply device through a toner supply opening. The imaging operation of the image forming apparatus is as follows. First, the photoconductor drum starts rotating counterclockwise. The photoconductor drum is neutralized by neutralization light so that the surface potential is averaged to a reference potential of from 0 to −150 V. The photoconductor drum is then charged by the charging roller so as to have a surface potential of about −1,000 V. The photoconductor drum is then irradiated with light emitted from the irradiator so that the irradiated portion (i.e., image area) has a surface potential of from 0 to −200 V. The developing device supplies the toner from the developing sleeve to the image area. As the photoconductor drum having the toner image thereon rotates, a sheet of transfer paper is fed from the paper feeding part at the right timing such that the leading edge of the sheet coincides with the leading edge of the toner image. Consequently, the toner image on the surface of the photoconductor drum is transferred onto the sheet by the transfer belt. The sheet is then fed to the fixing device. The toner image is fused on the transfer paper by application of heat and pressure. The sheet is ejected as a copy. Residual toner particles remaining on the photoconductor drum are removed by a cleaning blade in the cleaner. Subsequently, residual charges remaining on the photoconductor drum are neutralized with neutralization light. Thus, the photoconductor drum gets ready for a next image forming operation.

Example and Comparative Example toners and developers are evaluated with the above-described image forming apparatus with respect to the following items.

The evaluation results are shown in Table 1.

### (1) Image Quality

Image quality is comprehensively evaluated from the following two points: the degrees of defective transfer and background fouling.

The degree of defective transfer is determined by visually observing a black solid image which is produced after continuous printing on 5,000 sheets of paper by the image forming apparatus (i.e., a modified full-color digital copier IMAGIO MPC7500 from Ricoh Co., Ltd.).

The degree of background fouling is determined by quantifying toner particles present on the photoconductor during development of a white solid image after continuous printing on 5,000 sheets of paper by the image forming apparatus (i.e., a modified full-color digital copier IMAGIO MPC7500 from Ricoh Co., Ltd.). Specifically, the development of a white solid image is interrupted and toner particles present on the photoreceptor are transferred onto SCOTCH tape (from Sumitomo 3M). The SCOTCH tape having the toner particles is subjected to a measurement of image density by a spectrodensitometer (from X-Rite). When the image density difference between a blank SCOTCH tape is less than 0.30, the degree of background fouling is regarded as being low (good). When the image density difference between a blank SCOTCH tape is 0.30 or more, the degree of background fouling is regarded as being high (poor).

Comprehensive image quality is graded into the following three ranks: A (good), B (acceptable), and C (poor).

### (2) Charge Retention Capability

Charge retention capability is evaluated with a blow-off charge quantity measuring device from Toshiba Chemical Corporation and an E-SPART ANALYZER (Model EST-II) from Hosokawa Micron Corporation.

Each toner is mixed with the carrier by stirring them with a ball mill for 1 minute to prepare a developer having a toner concentration of 7%.

After the 1-minute stirring, the developer is allowed to stand still a vessel. Thirty minutes and sixty minutes later, the developer is subjected to a measurement of Q/M charge quantity and charge quantity distribution.

Q/M Charge quantity is measured by the blow-off charge quantity measuring device from Toshiba Chemical Corporation. Evaluation is made in terms of a percentage of the Q/M charge quantity measured after 30 minutes and 60 minutes to that measured after 1-minute still standing based on the following criteria.

Evaluation Criteria
AA: not less than 90% and not greater than 100%
A: not less than 75% and less than 90%
B: not less than 50% and less than 75%
C: not less than 0% and less than 50%

Charge quantity distribution is measured by the E-SPART ANALYZER (Model EST-II) from Hosokawa Micron Corporation. Evaluation is made in terms of the absolute value of the difference in the position of the peak value observed in a charge quantity distribution chart, between those measured after 30 minutes and 60 minutes and that measured after 1-minute still standing based on the following criteria.

Evaluation Criteria
AA: not greater than 5 μC/g
A: greater than 5 μC/g and not greater than 10 μC/g
B: greater than 10 μC/g and not greater than 15 μC/g
C: greater than 15 μC/g

TABLE 1

| | | Charge Retention Capability | |
|---|---|---|---|
| | | Q/M charge quantity | Charge quantity |
| | | (measured by blow- | distribution |
| | | off charge quantity | (measured by E- |
| | | measuring device | SPART ANALYZER |
| | Image | from Toshiba | from Hosokawa |
| | Quality | Chemical Corporation) | Micron Corporation) |
| Example 1 | A | AA | AA |
| Example 2 | A | A | A |
| Example 3 | A | A | AA |
| Example 4 | B | AA | A |
| Comparative | B | A | C |
| Example 1 | | | |
| Comparative | A | B | C |
| Example 2 | | | |

The evaluation results indicate that toners containing inorganic-layer-containing resin particles have significantly improved in charge retention capability.

What is claimed is:

1. A toner, comprising:
mother toner particles, each including:
a binder resin; and
inorganic-layer-containing resin particles, each including:
a resin particle; and
an inorganic layer on the surface of the resin particle.

2. The toner according to claim 1, wherein the inorganic layer includes at least one member selected from the group consisting of Si, Al, Mg, and Ca.

3. The toner according to claim 1, wherein the inorganic layer includes silica.

4. The toner according to claim 1, wherein a content rate of the inorganic-layer-containing resin particles in the mother toner particle is from 0.1% to 50% by weight.

5. The toner according to claim 1, wherein the mother toner particles have a volume average particle diameter (Dv) of from 3.0 to 6.0 μm.

6. The toner according to claim 1, wherein a ratio (Dv/Dn) of a volume average particle diameter (Dv) to a number average particle diameter (Dn) of the mother toner particles is from 1.05 to 1.25.

7. A developer, comprising:
the toner according to claim 1; and
a carrier.

8. A developer container, comprising:
a container; and
the toner according to claim 1 contained in the container.

9. An image forming apparatus, comprising:
an electrostatic latent image bearer;
an electrostatic latent image forming device to form an electrostatic latent image on the electrostatic latent image bearer; and
a developing device to develop the electrostatic latent image formed on the electrostatic latent image bearer into a visible image with the toner according to claim 1.
